(19) United States
(12) Patent Application Publication
(10) Pub. No.: US 2005/0165622 A1
(43) Pub. Date: Jul. 28, 2005

(54) Medical diagnostic testing device with voice message capability

(76) Inventors: Gary T. Neel, Weston, FL (US); George R. Rounds, Brookfield, CT (US); Erick A. Hernandez, Margate, FL (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/764,974

(22) Filed: Jan. 26, 2004

(51) Int. Cl. G06F 17/60

(52) U.S. Cl. 705/2

(57) ABSTRACT

A medical diagnostic testing device is provided with a voice message capability to record one or more voice messages associated with a test result. When a stored test result is retrieved and displayed, the medical diagnostic testing device also plays the one or more recorded voice messages associated with the stored test result.

### BACKGROUND

1. Field of the Invention

The present invention relates to the field of medical diagnostic testing devices and, more particularly, to a medical diagnostic testing device with a voice message capability.

2. Description of Related Art

Currently, medical diagnostic testing devices, such as blood glucose meters, store test rest results, such as blood glucose readings, which a user or medical professional can later retrieve and review. However, in order to properly interpret test results that are reviewed at a later time, it is often helpful to have information regarding the user's condition at the time the test result was obtained, e.g., what the user had eaten or how much the user had exercised. In one approach, a user could keep track of this information by keeping a journal, e.g., on paper or on a computer. However, this approach can be difficult or inconvenient for many users. For many users, the easiest and most natural way to keep track of information relevant to a test result may be to record a voice message or “memo” when the test result is obtained. However, although medical diagnostic testing devices have been specially designed for the visually impaired to “speak” test results, there remains a need to help users record voice messages that can be used to interpret their test results.

### SUMMARY

In a first principal aspect, the present invention provides a method of using a medical diagnostic testing device. In accordance with the method, a test result is obtained using the medical diagnostic testing device. The test result is stored in the medical diagnostic testing device. A voice message, associated with the test result, is recorded in the medical diagnostic testing device.

In a second principal aspect, the present invention provides a medical diagnostic testing device comprising: a testing system for obtaining a test result; a memory for storing the test result; and an audio system for recording a voice message associated with the test result.

In a third principal aspect, the present invention provides an improvement to a medical diagnostic testing device that obtains and stores test results. The improvement comprises an audio system for recording a voice message associated with a test result.

### BRIEF DESCRIPTION OF THE DRAWINGS

FIG. 1 is front view of a medical diagnostic testing device, in accordance with an exemplary embodiment of the present invention.

FIG. 2 is a functional block diagram of the medical diagnostic testing device of FIG. 1, in accordance with an exemplary embodiment of the present invention.

### DETAILED DESCRIPTION OF EXEMPLARY EMBODIMENTS

The present invention, in exemplary embodiments, relates to a medical diagnostic testing device with a voice message capability. The medical diagnostic testing device is a device, often configured to be hand-held, that is used to conduct one or more types of medical diagnostic tests on one or more types of samples. The sample is typically a biological material, such as blood, urine, or saliva. The test performed on the sample is typically a qualitative or quantitative test to determine the presence of or amount of one or more analytes in the sample. Such analytes could be glucose, cholesterol, human choriogonadotropin (HCG), hemoglobin A1c, fructosamine, carbohydrates, tumor markers, lead, anti-epilepsy drugs, bilirubin, liver function markers, toxins or their metabolites, drugs of abuse, blood coagulation factors (PT, APTT), or others. For example, the medical diagnostic testing device could be a glucose meter that determines glucose levels in whole blood samples. Such glucose meters are often used by people with medical conditions, such as diabetes, to monitor their blood glucose levels.

In many cases, the sample, e.g., whole blood, is applied to a carrier or sensor, such as a test strip, to perform the test. The test strip may include one or more reagents, such as glucose oxidase, and/or structures, such as electrodes, for performing a specific type of test or tests in conjunction with a specific type of medical diagnostic testing device. The medical diagnostic testing device may interact with the test strip to obtain one or more measurements and then determine a test result based on the one or more measurements. The measurements may include optical measurements, which may involve, for example, reflection, transmission, scattering, absorption, fluorescence, or electrochemiluminescence. Examples of optical measurement techniques and systems are disclosed in U.S. Pat. Nos. 6,040,195 and 6,284,550 and in U.S. patent application Ser. No. 09/984,948, filed on Oct. 31, 2001, which are incorporated herein by reference. Alternatively, the measurements may include electrical measurements, which may involve, for example, coulometry, amperometry, or potentiometry. Examples of electrical measurement techniques and systems are disclosed in U.S. patent application Ser. No. 10/286,648, filed on Nov. 1, 2002 and in U.S. patent application Ser. No. 10/420,995, filed on Apr. 21, 2003, which are incorporated herein by reference.

When the medical diagnostic testing device determines the test result, it may convey the test result to the user, e.g., by displaying the test result on a display. For example, the medical diagnostic testing device may display a glucose level expressed in terms of mg/dL. The medical diagnostic testing device may also store the test result in a memory. Thus, after obtaining a plurality of test results, the medical diagnostic testing device may have a plurality of test results stored in its memory. The user may be able to selectively retrieve these stored test results. For example, the user may be able to scroll through the plurality of stored test results, with the medical diagnostic testing device displaying each successive test result that it retrieves from its memory.

In accordance with exemplary embodiments of the present invention, the medical diagnostic testing device also includes a voice message capability. For example, when the medical diagnostic testing device obtains a test result, the user may also be able to record one or more voice messages associated with that test result. Thus, when the medical diagnostic device testing device stores the test result, it may also store one or more recorded voice messages, such that they are associated with the test result. For example, a stored test result and its associated voice message(s) may comprise a “test record” in the medical diagnostic testing device. The user may then be able to selectively retrieve the stored test results, and their associated voice messages, at a later time. Thus, when the medical diagnostic testing device displays a stored test result, as requested by the user, the medical diagnostic testing device may also play the voice message or voice messages associated with the stored test result.

This voice message capability may beneficially allow the user to provide information that relates to the test result. For example, the test results could be blood glucose levels and the voice messages may concern the user's exercise habits, diet, medication, thoughts, feelings, and/or sense of wellness, which may be correlated to blood glucose levels. Thus, when the medical diagnostic testing device displays a high blood glucose level, e.g., 300 mg/dL, the user may record a voice message that explains the high level: “I had two doughnuts for lunch.” When the medical diagnostic testing device displays a low blood glucose level, e.g., 80 mg/dL, the user may record a voice message that explains the low level: “I exercised this morning with no breakfast.” By displaying stored blood glucose levels and playing the associated voice messages, the user can learn what has helped keep his blood glucose levels under control and what has made his blood glucose levels out of control. Medical professionals could also review the stored blood glucose levels and the associated voice messages to monitor the user's progress and to make appropriate recommendations on how the user could improve.

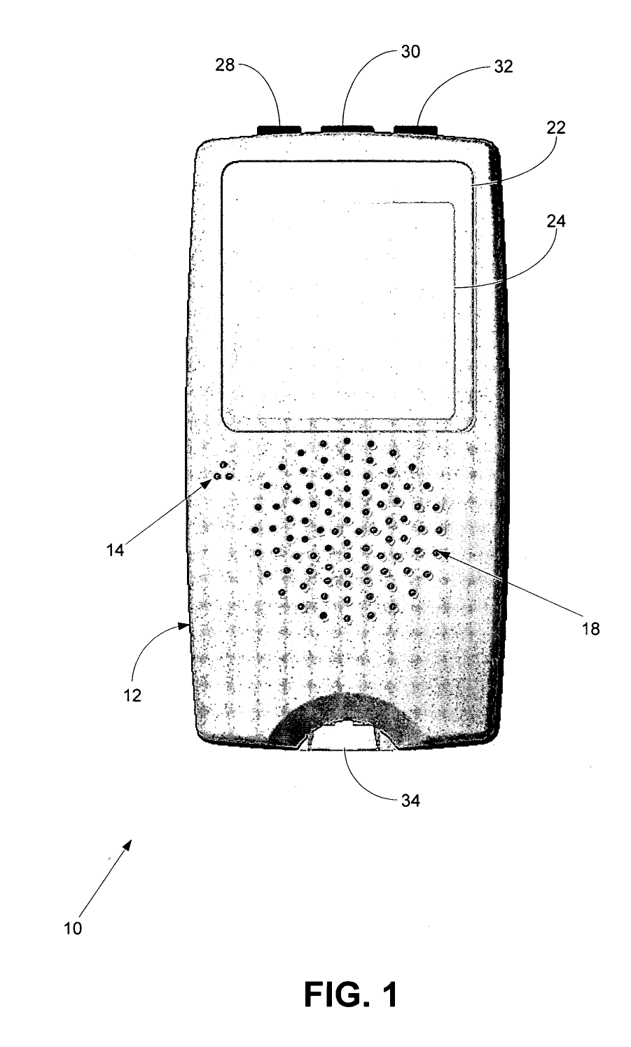

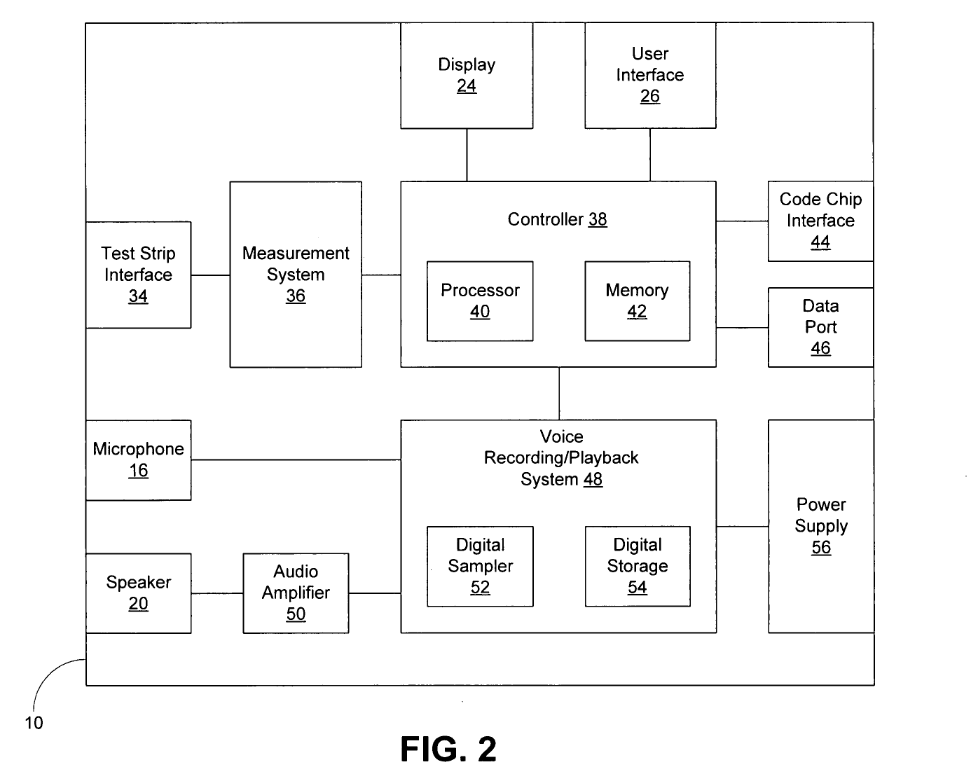

FIG. 1 is a front view of a medical diagnostic testing device 10, and FIG. 2 is a functional block diagram thereof, in accordance with an exemplary embodiment. Medical diagnostic testing device 10 may include a housing 12 that is sized and shaped so as to be conveniently held in a typical user's hand. To accommodate voice messaging capability, the front of housing 12 may include a microphone port 14 for audio access to a microphone 16 and a speaker port 18 for audio access to a speaker 20. Medical diagnostic testing device 10 may use microphone 16 to receive voice messages to be recorded, and medical diagnostic testing device 10 may use speaker 20 to play previously recorded voice messages.

The front of housing 12 may also include a window 22 for visual access to a display 24. Display 24 could be a liquid crystal display (LCD) or some other type of display. Medical diagnostic testing device 10 may use display 24 to display information and/or instructions to the user, e.g., in textual, or graphical form. For example, medical diagnostic testing device 10 may use display 24 to display test results.

A user interface 26 may also be mounted on housing 12. User interface 26 may include one or more buttons, keys, switches, controls, touch sensitive surfaces, and/or other components to receive input from the user. Such input may include user instructions for operating medical diagnostic testing device 10. In an exemplary embodiment, the user instructions may include a record instruction, to record a voice message, and a retrieve instruction to retrieve stored test results and their associated recorded voice messages.

To provide the capability of receiving these user instructions, user interface 26 may include buttons 28, 30, and 32, as shown in FIG. 1. Button 30 may be used to receive a record instruction. Thus, pressing button 30 may cause medical diagnostic testing device 10 to record a voice message associated with a test result currently being displayed on display 24. The displayed test result could be a test result that medical diagnostic testing device 10 just obtained, or it could be a stored test result that medical diagnostic testing device 10 retrieved in response to a retrieve instruction. Buttons 28 and 32 may be used to receive retrieve instructions. For example, buttons 28 and 32 may be used to scroll up and down, respectively, through an ordered set of stored test results and their associated voice messages. Thus, when button 28 (or button 32) is pressed, medical diagnostic testing device 10 may display on display 24 the previous (or next) stored test result and play through speaker 20 the voice message or messages associated with the stored test result. In an exemplary embodiment, medical diagnostic testing device 10 may order stored test results based on when the test results were obtained, i.e., in chronological order. Alternatively, medical device testing device 10 may order stored test results in other ways.

In addition to, or instead of, record button 30 and scroll buttons 28 and 32, user interface 26 may include other controls. For example, user interface 26 may include a volume control for controlling the volume at which recorded voice messages are played back through speaker 20. User interface 26 may also include one or more controls for turning the voice message recording and/or playback features on or off.

A test strip interface 34 may be mounted on housing 12. Test strip interface 34 may be used to receive one or more test strips for measurement. Test strip interface 34 may configured so as to position the test strip appropriately for measurement. Test strip interface may also include various structures for interacting with the test strip, depending on what type of measurements are used. For example, if electrical measurements are used, then test strip interface 34 may include one or more electrical contacts for electrically connecting to one or more corresponding electrical contacts on the test strip. If optical measurements are used, then test strip interface 34 may include one or more optical components, such as light emitting diodes (LEDs) and/or photodetectors.

As shown in FIG. 2, a measurement system 36 may interact with test strips via test strip interface 34 to obtain measurements. Measurement system 36 may, in turn, be coupled to a controller 38. Controller 38 may control measurement system 36 and may determine test results based on the measurements obtained by measurement system 36. The structure of measurement system 36 may depend on the type of measurements that are used. Thus, if electrical measurements are used, then measurement system 36 may include digital-to-analog (D/A) converters, for applying electrical signals to the test strip, via test strip interface 34, based on instructions from controller 38, and analog-to-digital (A/D) converters, for measuring electrical signals from the test strip, via test strip interface 34. If optical measurements are used, then measurement system 36 may control one or more LEDs in test strip interface 34, based on instructions from controller 38, and may include circuitry for measuring electrical signals from one or more photodetectors in test strip interface 34.

Controller 38 may also control many of the other functions of medical diagnostic testing device 10. In an exemplary embodiment, controller 38 includes a processor 40 and a memory 42. Memory 42 may include volatile memory, such as RAM, and/or non-volatile memory, such as flash memory. Memory 42 may store data, such as test results. Memory 42 may also store machine language instructions, i.e., software or firmware programming, that are executed by processor 40 to control the functioning of controller 38. Such programming may include one or more algorithms by which controller 38 determines test results based on the measurements from measurement system 36. In many cases, such algorithms may make use of calibration parameters that are specific for particular lots of test strips. These calibration parameters may be entered into medical diagnostic testing device 10 in various ways and may be stored in memory 42. In one approach, the calibration parameters may be read from a removable memory module or “code chip” that the user inserts into medical diagnostic testing device 10 to read a particular lot of test strips. Thus, medical diagnostic testing device 10 may include a code chip interface 44, coupled to controller 38, for receiving such removable memory modules or “code chips.”

Controller 38 may be coupled to display 24 to display information such as test results. Controller 38 may also be coupled to user interface 26 so as to be able to receive user instructions such as record instructions and retrieve instructions. Controller 38 may control the functioning of medical diagnostic testing device 10, i.e., in accordance with its programming, in response to such user instructions, as described in more detail below. Controller 38 may also be coupled to a data port 46 for communicating with external devices. For example, medical diagnostic testing device 10 may upload or download test results, voice messages, and/or user instructions via data port 46.

To enable voice message capability, medical diagnostic testing device 10 may include a voice recording/playback system 48 for recording voice messages and for playing back previously recorded voice messages. Thus, voice system 48 may be coupled to microphone 16 for receiving voice messages, and voice system 48 may be coupled to speaker 20, e.g., via an audio amplifier 50, for playing back recorded voice messages. The operations of voice system 48 may be controlled by controller 38, as described in more detail below.

In an exemplary embodiment, voice recording/playback system 48 records and stores voice messages digitally. Thus, voice recording/playback system 48 may include a digital sampler 52 for converting analog voice signals, i.e., voice messages received by microphone 16, into digital samples at a predetermined sampling rate, e.g., at a 4 kHz to 8 kHz sampling rate. Voice recording/playback system 48 may also include digital storage 54 for storing the digital samples from digital sampler 52. Thus, to play black a recorded voice message, the digital samples corresponding to the recorded voice message may be read from digital sampler 52 and provided to speaker 20, e.g., via a low-pass filter (not shown) and audio amplifier 50. In an exemplary embodiment, voice recording/playback system 48 may be provided as an integrated circuit, such as the ISD5108 ChipCorder® voice record and playback integrated circuit, available from Winbond Electronics Corporation America, San Jose, Calif.

Medical diagnostic testing device 10 may also include a power supply 56. In an exemplary embodiment, power supply 56 includes one or more batteries and may also include a voltage regulator. In some embodiments, power supply 56 may enable medical diagnostic device 10 to be connected to an external source of power. Although FIG. 2 shows power supply 56 connected to voice system 48, it is to be understood that power supply 56 may also power controller 38, measurement system 36, display 24, and other components in medical diagnostic testing system 10.

As noted above, controller 38 may control voice recording/playback system 48, e.g., in response to user instructions such as record instructions and retrieve instructions. Thus, when controller 38 determines a test result, e.g., based on measurements from measurement system 36 on a test strip received in test strip interface 34, and displays the test result on display 24 and stores the test result in memory 42, controller 38 may receive a record instruction, e.g., from user interface 26. In response to the record instruction, controller 38 may control voice system 48 so that it records a voice message received by microphone 16.

The beginning, end, and/or duration of a voice message may be defined in various ways. For example, the beginning and end of a voice message may be defined by the user, e.g., by when the user depresses and releases record button 30. As another example, the beginning and end of a voice message may be defined automatically based on voice levels, i.e., based on when the user begins speaking and when the user finishes speaking. Alternatively, other approaches could be used to define the beginnings and ends of voice messages. In some cases, each voice message may have a fixed duration.

In addition to causing voice system 48 to record the voice message, controller 38 may also store an indication in memory 42 that the test result it just obtained and stored has an associated voice message stored at a given location, e.g., an address, in digital storage 54. Alternatively, controller 38 may associate stored test results with voice messages by storing the test results in digital storage 54 with their associated voice messages. Other ways of associating test results with voice messages may also be used so that a test result and the one or more voice messages associated with it may be treated as part of the same test record. In this way, when controller 38 retrieves a stored test result, controller 38 may also locate the one or more voice messages associated with the stored test result.

For example, when controller 38 receives a retrieve instruction, e.g., from user interface 26, controller 38 may retrieve a stored test result from memory 42 along with information regarding the locations of any associated voice messages that may be stored in digital storage 54. Controller 38 may then display on display 24 the stored test result that it retrieved, and controller 38 may also use the location information it retrieved with the stored test result to cause voice system 48 to play on speaker 20 the one or more recorded voice messages associated with the stored test result.

In addition to recording and playing back voice messages associated with test results, voice system 48 may perform other functions. For example, voice system 48 may have a more general voice message capability to allow the user to record and playback voice messages that are not associated with a particular test result. In another example, voice system 48 may be provided with pre-recorded voice messages. Such pre-recorded voice messages could, for example, serve as voice instructions to the user, such as how to use, set up, and/or troubleshoot medical diagnostic testing device 10. Voice system 48 may also include a speech recognition capability to recognize spoken instructions from the user. Voice system 48 could also be provided with other voice-related functions and capabilities.

Preferred embodiments of the present invention have been described above. Those skilled in the art will understand, however, that changes and modifications may be made to these embodiments without departing from the true scope and spirit of the invention, which is defined by the claims.

1. A method of using a medical diagnostic testing device, said method comprising:
obtaining a test result using said medical diagnostic testing device;
storing said test result in said medical diagnostic testing device; and
recording a voice message, associated with said test result, in said medical diagnostic test device.

2. The method of claim 1, wherein obtaining a test result using said medical diagnostic testing device comprises:
applying a sample to a test strip;
said medical diagnostic testing device interacting with said test strip, with said sample applied thereto, to obtain at least one measurement; and
determining said test result based on said at least one measurement.

3. The method of claim 2, wherein said sample is whole blood.

4. The method of claim 3, wherein said test result is a glucose level in said sample.

5. The method of claim 2, wherein said at least one measurement includes an optical measurement.

6. The method of claim 2, wherein said at least one measurement includes an electrical measurement.

7. The method of claim 1, further comprising:
said medical diagnostic testing device displaying said test result.

8. The method of claim 1, further comprising:
said medical diagnostic testing device displaying a stored test result.

9. The method of claim 1, further comprising:
said medical diagnostic testing device playing a recorded voice message.

10. The method of claim 1, further comprising:
said medical diagnostic testing device receiving a retrieve instruction; and
in response to said retrieve instruction, said medical diagnostic testing device displaying a stored test result and playing a recorded voice message associated with said stored test result.

11. The method of claim 1, wherein recording a voice message comprises:
receiving said voice message;
converting said voice message into digital samples; and
storing said digital samples.

12. A medical diagnostic testing device, comprising:
a testing system for obtaining a test result;
a memory for storing said test result; and
an audio system for recording a voice message associated with said test result.

13. The medical diagnostic testing device of claim 12, further comprising:
a test strip interface for receiving a test strip.

14. The medical diagnostic testing device of claim 13, wherein said testing system comprises:
a measurement system for interacting with said test strip, with a sample applied thereto, to obtain at least one measurement; and
a controller for controlling said measurement system, said controller determining said test result based on said at least one measurement.

15. The medical diagnostic testing device of claim 14, wherein said sample is whole blood.

16. The medical diagnostic testing device of claim 15, wherein said test result is a glucose level in said sample.

17. The medical diagnostic testing device of claim 14, wherein said at least one measurement includes an optical measurement.

18. The medical diagnostic testing device of claim 14, wherein said at least one measurement includes an electrical measurement.

19. The medical diagnostic testing device of claim 12, further comprising a display for displaying said test result.

20. The medical diagnostic testing device of claim 12, wherein said audio system comprises:
a microphone for receiving said voice message;
a digital sampler to provide digital samples of said voice message; and
digital storage for storing said digital samples of said voice message.

21. The medical diagnostic testing device of claim 20, wherein said audio system further comprises:
a speaker for playing said voice message stored in said digital storage.

22. The medical diagnostic testing device of claim 12, further comprising a user interface for receiving at least one user instruction for operating said medical diagnostic testing device.

23. The medical diagnostic testing device of claim 22, wherein said at least one user instruction includes a record instruction, wherein said medical diagnostic testing device records said voice message in response to said record instruction.

24. The medical diagnostic testing device of claim 22, wherein said at least one user instruction includes a retrieve instruction, wherein said medical diagnostic testing device displays a stored test result and plays a recorded voice message associated with said stored test result in response to said retrieve instruction.

25. In a medical diagnostic testing device that obtains and stores test results, the improvement comprising:
an audio system for recording a voice message associated with a test result.

26. The improvement of claim 25, wherein said audio system includes a microphone for receiving said voice message.

27. The improvement of claim 26, wherein said audio system includes digital storage for digitally storing a recorded voice message.

28. The improvement of claim 27, wherein said audio system includes a speaker for playing said recorded voice message.

29. The improvement of claim 25, further comprising:
a user interface for receiving a record instruction, wherein said medical diagnostic testing device records said voice message in response to said record instruction.

30. The improvement of claim 25, further comprising:
a user interface for receiving a retrieve instruction, wherein said medical diagnostic testing device displays a stored test result and plays a recorded voice message associated with said stored test result in response to said retrieve instruction.
